(19) United States
(12) Patent Application Publication
(10) Pub. No.: US 2015/0185153 A1
(43) Pub. Date: Jul. 2, 2015

(54) Pesticide Residue Detection Method

(71) Applicants: Nuctech Company Limited, Beijing (CN); Tsinghua University, Beijing (CN)

(72) Inventors: Li Zhang, Beijing (CN); Li Jiang, Beijing (CN); Jianhong Zhang, Beijing (CN); Hongqiu Wang, Beijing (CN); Yumin Yi, Beijing (CN)

(73) Assignees: Tsinghua Yuan, Beijing (CN); Nuctech Company Limited, Beijing (CN)

(21) Appl. No.: 14/575,381

(22) Filed: Dec. 18, 2014

(30) Foreign Application Priority Data
Dec. 30, 2013 (CN) 201310746277.4

(51) Int. Cl. G01N 21/65

(52) U.S. Cl. CPC G01N 21/65

(57) ABSTRACT

Embodiments of the present invention disclose a pesticide residue detection method, comprising the steps: (a) irradiating a sample to be detected by an exciting light and collecting a Raman scattered light from the sample; (b) acquiring a Raman spectrum of the sample from the collected Raman scattered light; and (c) comparing the Raman spectrum with reference Raman spectra for known pesticides in a reference Raman library to determine composition and concentration of the pesticide residue in the sample. The method may achieve effective, convenient and accurate inspection of the pesticide residue in foods, in particular suitable for rapid detection.

### CROSS-REFERENCE TO RELATED APPLICATION

This application claims the benefit of Chinese Patent Application No. 201310746277.4 filed on Dec. 30, 2013 in the State Intellectual Property Office of China, the whole disclosure of which is incorporated herein by reference.

### BACKGROUND OF THE INVENTION

The present disclosure relates to the field of pesticide residue detection, and in particular, to a method for detecting pesticide residue in foods using Raman spectroscopy.

Pesticides play an important role in insect disease prevention of crops and thus produce great benefit for agriculture. However, excessive use of pesticides is harmful to the environment and food security. Many countries around the world have regulations for maximum limit of relative pesticide residue. It is crucial to detect the pesticide residue. Presently, analysis and detection of the pesticide residue are mainly achieved by instruments in the lab. In many cases, such as in-situ detection, it is significant to establish a fast, convenient and low cost method for determination of pesticide residues is.

### SUMMARY OF THE INVENTION

An embodiment of the present invention provides a pesticide residue detection method, comprising the steps:
(a) irradiating a sample to be detected by an exciting light and collecting a Raman scattered light from the sample;
(b) acquiring a Raman spectrum of the sample from the collected Raman scattered light; and
(c) comparing the Raman spectrum with reference Raman spectra for known pesticides in a reference Raman spectrum library to determine composition and concentration of pesticide residue in the sample.

In an embodiment, the reference Raman spectrum library may comprise reference Raman spectra of food systems containing pesticide residue of known compositions and concentrations and/or reference Raman spectra of food systems excluding any pesticide residue.

In an embodiment, the step (c) may comprise:
(c1) acquiring a position of a characterizing peak from the Raman spectrum of the sample to be detected and comparing it with positions of the corresponding characterizing peaks in the reference Raman spectra to determine whether the sample to be detected contains a certain pesticide residue or not; and
(c2) if it is determined that the sample to be detected contains the pesticide residue, extracting a peak intensity or peak area of the characterizing peak of the Raman spectrum of the sample to be detected and comparing it with those of the reference Raman spectra to determine the concentration of the pesticide residue in the sample to be detected.

In an embodiment, the pesticide residue detection method may further comprise the following step before the step (a):
(o) measuring Raman spectra of reference samples containing pesticide of known compositions and concentrations to obtain reference Raman spectra so as to establish the reference Raman spectrum library.

In an embodiment, the pesticide residue detection method may further comprise the following step between the step (o) and the step (a):
(p) establishing a table, graph or function of the concentrations of pesticide residue vs. the peak intensities or peak areas of the characterizing peaks in the Raman spectrum on basis of the reference Raman spectra of the reference samples containing pesticide of known compositions and concentrations.

In an embodiment, the step (c) may comprise:
(c3) acquiring a position of a characterizing peak from the Raman spectrum of the sample to be detected and comparing it with the position of the corresponding characterizing peak in the reference Raman spectra to determine whether the sample to be detected contains a certain pesticide residue or not; and
(c4) if it is determined that the sample to be detected contains the pesticide residue, extracting a peak intensity or peak area of the characterizing peak of the Raman spectrum of the sample to be detected and determining the concentration of the pesticide residue in the sample to be detected on basis of the table, graph or function of the concentrations of pesticide residue vs. the peak intensities or peak areas of the characterizing peaks in the Raman spectra.

In an embodiment, the sample to be detected is formed by mixing a process fluid of food to be detected with a nano-enhancement material.

In an embodiment, the process fluid of food to be detected may be produced by carrying out a crush and extraction process on the food to be detected.

In an embodiment, the process fluid of food to be detected is purified and concentrated before it is mixed with the nano-enhancement material.

In an embodiment, the nano-enhancement material may comprise a metal nano-material, the metal comprising gold, silver, cooper, iron, cobalt, nickel, palladium or platinum or any combination thereof.

### BRIEF DESCRIPTION OF THE DRAWINGS

FIG. 1 is a schematic flow chart of a pesticide residue detection method according to an embodiment of the present invention;

FIG. 2 shows a schematic flow chart of a method for determining the composition and concentration of pesticide residue in a sample to be detected according to an embodiment of the present invention;

FIG. 3 shows a schematic flow chart of a method for determining the composition and concentration of pesticide residue in a sample to be detected according to another embodiment of the present invention;

FIG. 4 shows schematically reference Raman spectrum graphs of phosmet of different concentrations;

FIG. 5 is a graph schematically showing a relation between the concentration and peak intensity of the characterizing peaks of the reference Raman spectra of phosmet; and

FIG. 6 shows schematically Raman spectrum graphs of process fluid of apples containing pesticide of isocarbophos of different concentrations.

### DETAILED DESCRIPTION OF THE PREFERRED EMBODIMENTS

Exemplary embodiments of the present invention will be described hereinafter in detail with reference to the attached drawings, wherein the like reference numerals refer to the like elements. The present invention may, however, be embodied in many different forms and should not be construed as being limited to the embodiment set forth herein; rather, these embodiments are provided so that the present invention will be thorough and complete, and will fully convey the concept of the disclosure to those skilled in the art.

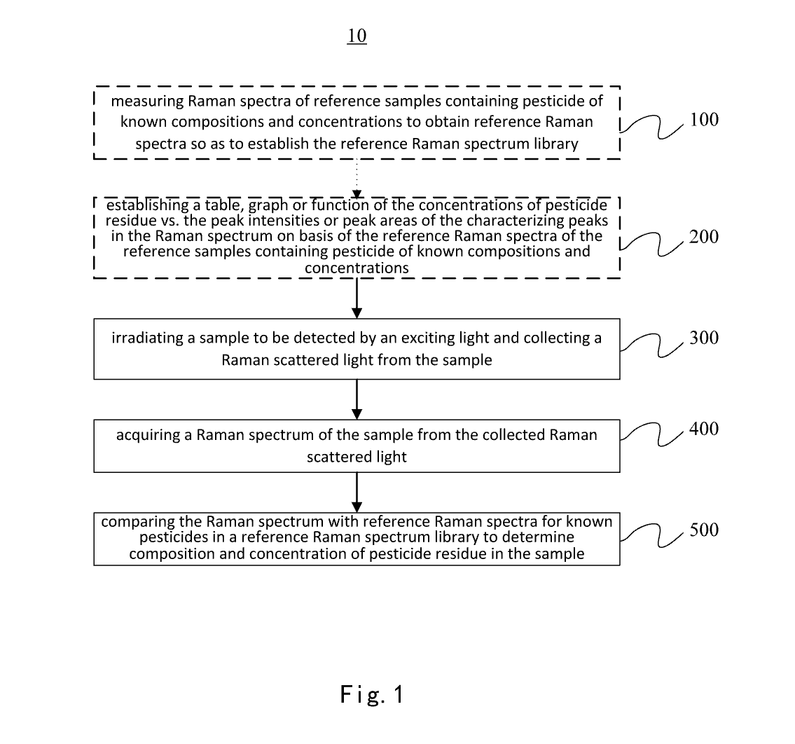

FIG. 1 is a schematic flow chart of a pesticide residue detection method according to an embodiment of the present invention. The pesticide residue detection method 10 may include (as illustrated in solid blocks in FIG. 1):

Step 300: irradiating a sample to be detected by an exciting light and collecting a Raman scattered light from the sample;

Step 400: acquiring a Raman spectrum of the sample from the collected Raman scattered light; and

Step 500: comparing the Raman spectrum with reference Raman spectra for known pesticides in a reference Raman spectrum library to determine composition and concentration of the pesticide residue in the sample.

As an example, the pesticide residue detection method 10 may further include optional steps (as illustrated in dashed block 100 in FIG. 1):

Step 100: measuring Raman spectra of reference samples containing pesticide of known compositions and concentrations to obtain reference Raman spectraso as to establish the reference Raman spectrum library.

The Step 100 may be performed along with the subsequent Steps 300-500 in the same field, that is, the step of establishing the reference Raman spectrum library may be performed in the field of detecting the pesticide residue. In this way, the consistency and stability of the detection conditions for the reference samples and those for the sample to be detected may be ensured to the largest extent. However, in order to reduce field detection time and procedures, the reference Raman spectrum library may not be established in the field of detecting the pesticide residue, but may be established in advance (for example in the lab) in accordance with measurements of reference samples. In addition, for example, commercially available standard Raman spectrum library may also be used as the reference Raman spectrum library in the embodiment of the present invention. The reference Raman spectrum library may be replaced or replenished as requirement of detection (for example, new species of pesticides).

In order to detect the concentration of pesticide residue, the reference Raman spectrum library needs to contain reference Raman spectra for different concentrations of the pesticide. In contrast, in the conventional Raman spectrum detection, only species of pesticide are detected, but the concentrations are not detected. Thus, the reference Raman spectrum library for comparison will not contain Raman spectra for different concentrations. Further, in the pesticide residue detection, the pesticide residue is mixed in different food systems, including food components for example fatty acid, carbohydrate, organic acid and additives such as pigment or antiseptics, the Raman spectra of the sample to be detected may also be affected by different food systems(such as different types of foods). In order to eliminate the influence of the different food systems on the detection results, the reference Raman spectrum library may include reference Raman spectra of food systems containing pesticide residue of known compositions and concentrations, and/or reference Raman spectra of food systems excluding any pesticide residues. The detection results of the sample to be detected may be compared with the reference Raman spectra of food systems containing pesticide residue of known compositions and concentrations and calculations may be made on basis of them. From the reference Raman spectra of the food systems excluding any pesticide residues, the effects of different food systems to the Raman spectra may be derived and the effects may be used in seeking and determining the characterizing peak corresponding to the pesticide residue in the Raman spectrum of the sample to be detected.

It should be noted that the above term of “food systems” may include one kind of food, for example, fruit, vegetable, cake, or may include a plurality kinds of foods, even a mixture of a plurality of kinds of foods.

In order to improve the concentration detection of the pesticide residue, as an example, the pesticide residue detection method according to an embodiment of the present invention may further include the Step 200 (as illustrated by the dashed block 200 in FIG. 1): establishing a table, graph or function of the concentrations of pesticide residue vs. the peak intensities or peak areas of the characterizing peaks in the Raman spectra on basis of the reference Raman spectra of the reference samples containing pesticide of different concentrations.

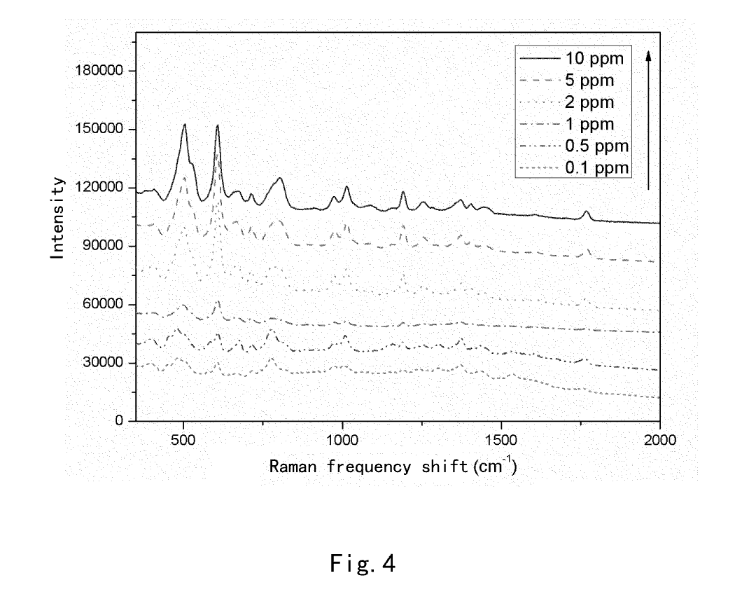

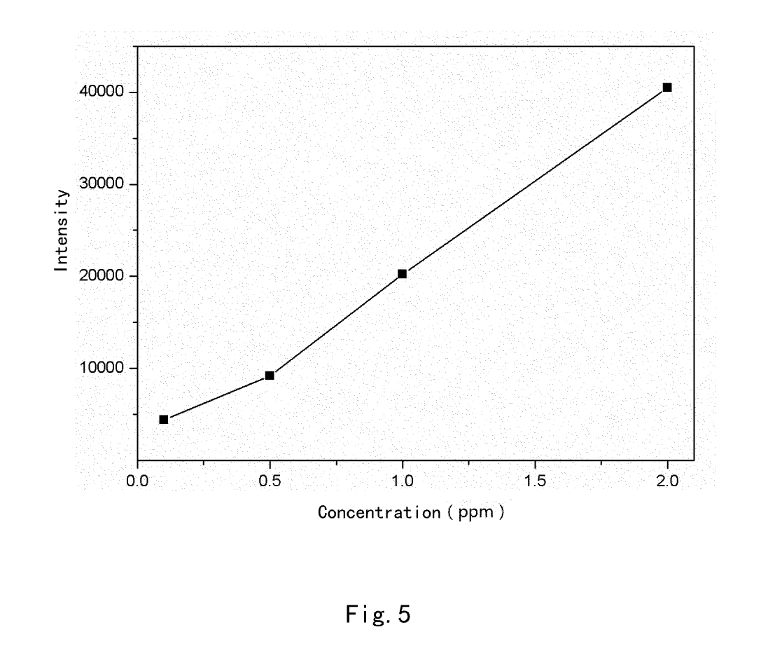

As an example, FIG. 4 provides Raman spectra of pesticide of phosmet with different concentrations. It shows Raman spectra of pesticide of phosmet with concentrations of 10 ppm, 5 ppm, 2 ppm, 1 ppm, 0.5 ppm and 0.1 ppm. As can be seen from FIG. 4, the peak intensities of the characterizing peaks in the Raman spectra are increased as the concentrations increase, and the characterizing peak may still be observed even when the pesticide concentration is as low as 0.1 ppm. On the other hand, the peak positions of the characterizing peaks (i.e., the position of frequency shift the characterizing peak corresponds to) do not change as the pesticide concentrations vary. Thus, for example, the characterizing peak at 609 cm−1 may be selected to establish the diagram between the peak intensity and the pesticide concentration, as illustrated in FIG. 5. Although in FIG. 5 the relation between the peak intensity of the characterizing peak and the pesticide concentration is established on basis of a linear relation, it is only an example. Alternatively, the relation of the peak intensity and the pesticide concentration may also be established by other means, for example, may be established by fitting on basis of such as second order or more order curve, parabola, or by listing tables, or in the form of function.

FIG. 5 explains the relation between the peak intensity of the characterizing peak and the pesticide concentration which is established only with reference to the characterizing peak at 609 cm−1. However, it is only an example. For example, the characterizing peak at other peak positions in FIG. 4 may be selected to establish the relation between the peak intensity and the pesticide concentration, or the relation between the peak area and the pesticide concentration may be established. Extraction of the peak area is more complex than extraction of peak intensity, but it may be less influenced by noise signals.

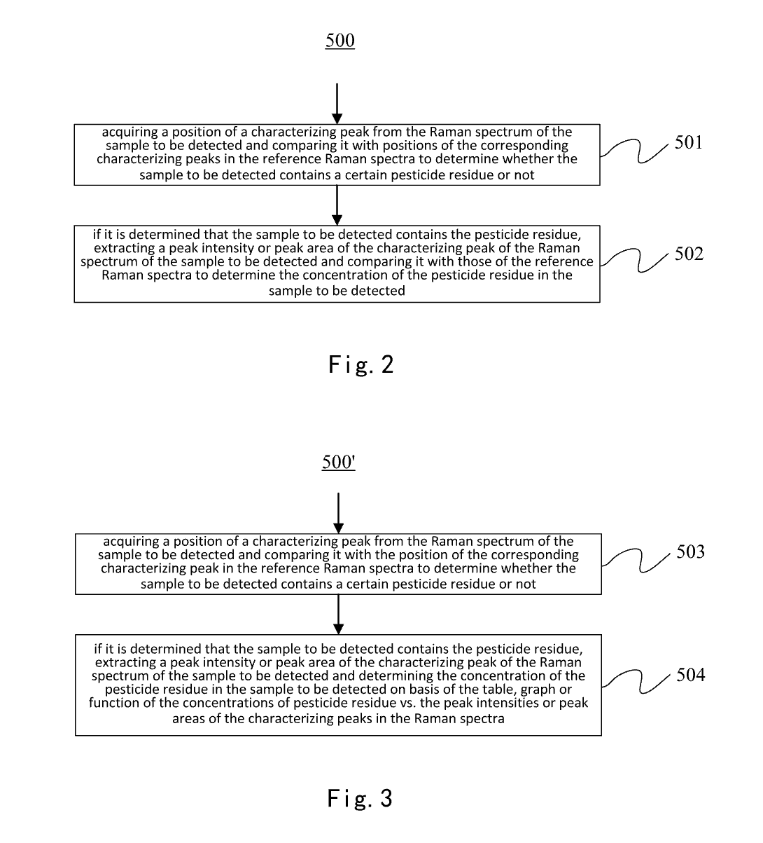

As an example, the Step 500 may include (as illustrated in FIG. 2):

Step 501: acquiring a position of a characterizing peak from the Raman spectrum of the sample to be detected and comparing it with the position of the corresponding characterizing peaks in the reference Raman spectra to determine whether the sample to be detected contains a certain pesticide residue or not; and

Step 502: if it is determined that the sample to be detected contains the pesticide residue, extracting a peak intensity or peak area of the characterizing peak of the Raman spectrum of the sample to be detected and comparing it with those of the reference Raman spectra to determine the concentration of the pesticide residue in the sample to be detected.

In the case that the relation between the peak intensity of the characterizing peak and the pesticide concentration has been established, the relation may also be used to determine the concentration of the pesticide residue in the sample to be detected, that is, the Step 500′ of comparing the Raman spectrum with reference Raman spectra for known pesticides to determine composition and concentration of the pesticide residue in the sample to be detected may alternatively include (as illustrated in FIG. 3):

Step 503: acquiring a position of a characterizing peak from the Raman spectrum of the sample to be detected and comparing it with the position of the corresponding characterizing peaks in the reference Raman spectra to determine whether the sample to be detected contains a certain pesticide residue or not; and

Step 504: if it is determined that the sample to be detected contains a certain pesticide residue, extracting a peak intensity or peak area of the characterizing peak of the Raman spectrum of the sample to be detected and determining the concentration of the pesticide residue in the sample to be detected on basis of the table, graph or function of the concentrations of pesticide residue vs. the peak intensities or peak areas of the characterizing peaks in the Raman spectra.

The pesticide residue detection method according to the embodiment of the present invention is easy and convenient to be performed, and has an accurate detection result due to the characteristics of Raman scattered light. The pesticide residue in foods can be detected by extracting small amount of samples from foods such as fruits, vegetables and the like.

In an example, in order to enhance the intensity of the Raman scattered light, the sample to be detected may be formed by mixing a process fluid of food to be detected with nano-enhancement material. The nano-enhancement material may include such as a metal nano-material, the metal including gold, silver, cooper, iron, cobalt, nickel, palladium or platinum or any combination thereof. Certainly, this is not necessary. Instead, the sample to be detected may not include nano-enhancement material.

In an example, the process fluid of food to be detected is produced by carrying out a crush and extraction process on the food to be detected. For example, the crush process may be done by mechanically crushing. For example, the extraction process may be done using an organic extraction agent. As an example, the process fluid of food to be detected may be purified and concentrated before it is mixed with the nano-enhancement material, so as to remove impurity and improve the purity of the sample to be detected. The purification process may for example be done by making the fluid pass through a column device or adding a purifying agent (for example absorbent) into it to eliminate the impurity which may disturb the pesticide residue detection (such as additives such as pigment, antiseptic or a certain compositions of the food itself). For example, the concentration process may be done by volatilizing the process fluid of the food to be detected suitably to improve the concentration of the potential pesticide residue in the process fluid for convenience of detection. In practice, the above purification and concentration processes may efficiently remove the disturbance of the impurity and control the concentration of the process fluid to improve the accuracy of pesticide residue detection.

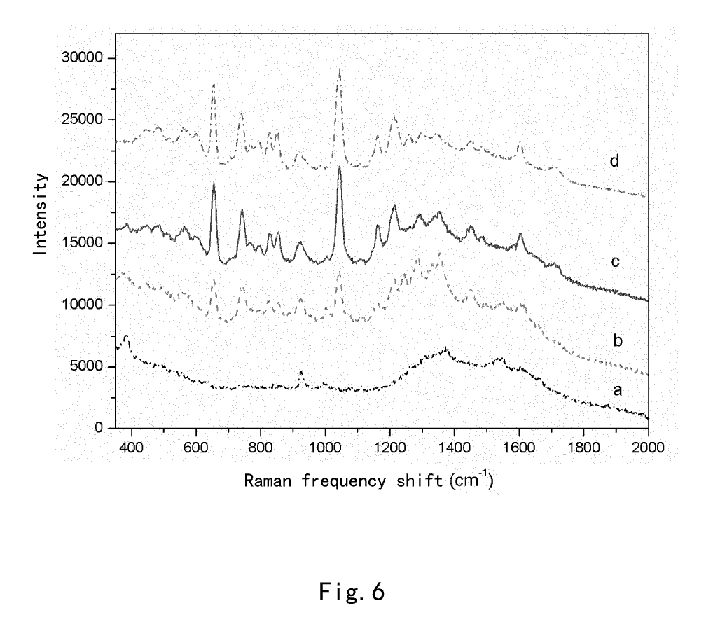

FIG. 6 shows an example of detecting the residue of pesticide of isocarbophos in the process fluid of apples according to the principle of the present invention. In FIG. 6, the curve a represents a surface enhanced (for example by enhancing nano materials) Raman spectrum of the process fluid of apples excluding pesticides. The curves b and c represent surface enhanced Raman spectra of the process fluid of apples containing 1 ppm and 10 ppm pesticides of isocarbophos. The curve d represents a surface enhanced Raman spectrum of 1 ppm pesticides of isocarbophos solution. As shown in FIG. 6, the curves d and c have the charactering peaks of pesticide isocarbophos, such as the charactering peaks at 655 cm−1, 743 cm−1 and 1043 cm−1. These charactering peaks are not present in the curve a of the process fluid of pure apple but appear in the curve d of pesticide of isocarbophos solution. Further, these charactering peaks have different peak intensities for different pesticide concentrations. In this way, the method according to the embodiment of the present invention can detect whether the process fluid of apples has pesticide residue.

The method according to the embodiment of the present invention may be used as a method for detecting the pesticide residue in foods conveniently and fast in the field.

Although the present invention has been explained with reference to the drawings, the embodiments shown in the drawings are only illustrative, instead of limiting the present invention.

Although some embodiments of the general inventive concept are illustrated and explained, it would be appreciated by those skilled in the art that modifications and variations may be made in these embodiments without departing from the principles and spirit of the general inventive concept of the disclosure, the scope of which is defined in the appended claims and their equivalents.

What is claimed is:

1. A pesticide residue detection method, comprising the steps of:
(a) irradiating a sample to be detected by an exciting light and collecting a Raman scattered light from the sample;
(b) acquiring a Raman spectrum of the sample from the collected Raman scattered light; and
(c) comparing the Raman spectrum with reference Raman spectra for known pesticides in a reference Raman spectrum library to determine composition and concentration of pesticide residue in the sample.

2. The pesticide residue detection method according to claim 1, wherein the reference Raman spectrum library comprises reference Raman spectra of food systems containing pesticide residue of known compositions and concentrations and/or reference Raman spectra of food systems excluding any pesticide residue.

3. The pesticide residue detection method according to claim 1, wherein the step (c) comprises:
(c1) acquiring a position of a characterizing peak from the Raman spectrum of the sample to be detected and comparing it with positions of the corresponding characterizing peaks in the reference Raman spectra to determine whether the sample to be detected contains a certain pesticide residue or not; and
(c2) if it is determined that the sample to be detected contains the pesticide residue, extracting a peak intensity or peak area of the characterizing peak of the Raman spectrum of the sample to be detected and comparing it with those of the reference Raman spectra to determine the concentration of the pesticide residue in the sample to be detected.

4. The pesticide residue detection method according to claim 1, further comprising the following step before the step (a):
(o) measuring Raman spectra of reference samples containing pesticide of known compositions and concentrations to obtain reference Raman spectra so as to establish the reference Raman spectrum library.

5. The pesticide residue detection method according to claim 4, further comprising the following step between the step (o) and the step (a):
(p) establishing a table, graph or function of the concentrations of pesticide residue vs. the peak intensities or peak areas of the characterizing peaks in the Raman spectrum on basis of the reference Raman spectra of the reference samples containing pesticide of known compositions and concentrations.

6. The pesticide residue detection method according to claim 5, wherein the step (c) comprises:
(c3) acquiring a position of a characterizing peak from the Raman spectrum of the sample to be detected and comparing it with the position of the corresponding characterizing peak in the reference Raman spectra to determine whether the sample to be detected contains a certain pesticide residue or not; and
(c4) if it is determined that the sample to be detected contains the pesticide residue, extracting a peak intensity or peak area of the characterizing peak of the Raman spectrum of the sample to be detected and determining the concentration of the pesticide residue in the sample to be detected on basis of the table, graph or function of the concentrations of pesticide residue vs. the peak intensities or peak areas of the characterizing peaks in the Raman spectra.

7. The pesticide residue detection method according to claim 1, wherein the sample to be detected is formed by mixing a process fluid of food to be detected with a nano-enhancement material.

8. The pesticide residue detection method according to claim 7, wherein the process fluid of food to be detected is produced by carrying out a crush and extraction process on the food to be detected.

9. The pesticide residue detection method according to claim 8, wherein the process fluid of food to be detected is purified and concentrated before it is mixed with the nano-enhancement material.

10. The pesticide residue detection method according to claim 7, wherein the nano-enhancement material comprises a metal nano-material, the metal comprising gold, silver, cooper, iron, cobalt, nickel, palladium or platinum or any combination thereof.
